(19) United States
(12) Patent Application Publication
(10) Pub. No.: US 2016/0104186 A1
(43) Pub. Date: Apr. 14, 2016

(54) METHODS, SYSTEMS, AND COMPUTER READABLE MEDIA FOR PROVIDING INFLIGHT BENEFITS VIA PURCHASE CARD TRANSACTIONS

(71) Applicant: MasterCard International Incorporated, Purchase, NY (US)

(72) Inventors: Stephen A. Parento, White Plains, NY (US); Sumeet Bhatt, Jericho, NY (US)

(21) Appl. No.: 14/514,317

(22) Filed: Oct. 14, 2014

(51) Int. Cl. G06Q 30/02

(52) U.S. Cl. CPC G06Q 30/0226

(57) ABSTRACT

Methods, systems, and computer readable media for providing inflight benefits via purchase card transactions are disclosed. An exemplary method includes at an airline perk management module (APMM), receiving an indication that an airline ticket is purchased using a loyalty card corresponding to a passenger enrolled in an airline perk program, identifying at least one airline perk associated with an aircraft seat assignment corresponding to the purchased airline ticket, and notifying an inflight service provider to deliver, inflight, the at least one identified airline perk to a passenger having the aircraft seat assignment. An exemplary system includes at least one processor and memory, whereby APMM utilizes the at least one processor and the memory to notify a merchant airline to deliver the at least one airline perk to a passenger having a seat assignment on an airline, the airline ticket for the seat assignment being purchased using a loyalty card.

### TECHNICAL FIELD

The subject matter described herein relates to payment card transactions and associated loyalty programs. More particularly, the subject matter described herein relates to systems, methods, and computer readable media for providing inflight benefits via payment card transactions.

### BACKGROUND

In general, a plurality of purchase-dependent loyalty or reward card programs and products currently exist, in which a cardholder purchaser is rewarded with instantaneous and/or accrued benefits or “perks”, not limited to discounts, free shipping, cash back bonuses, monetary rewards, gifts, points towards redeemable goods or services, etc. With respect to airline perks, loyalty and/or reward card programs include benefits not limited to the accrual of points or “miles” to put towards free/reduced airline tickets, free bag check, priority boarding, etc. Such products typically have exclusionary purchasing requirements, are not service oriented, and/or offer the same benefits to all cardholders. This results in restrictive loyalty card programs which are limited in value to merchants and cardholders.

Accordingly, there exists a need for improved systems, methods, and computer readable media for providing inflight benefits via payment card transactions.

### SUMMARY

According to one aspect, the subject matter described herein relates to, methods, systems, and computer readable media for providing inflight benefits via payment card transactions. A method of providing inflight benefits via payment card transactions may be provided via at an airline perk management module (APMM). The method may include receiving an indication that an airline ticket is purchased using a loyalty card corresponding to a passenger enrolled in an airline perk program, identifying at least one airline perk associated with an aircraft seat assignment corresponding to the purchased airline ticket, and notifying an inflight service provider to deliver, inflight, the at least one identified airline perk to a passenger having the aircraft seat assignment.

In some embodiments, a system for providing inflight benefits includes at least one processor, memory, and APMM utilizing the at least one processor and the memory. The APMM is configured to receive an indication that an airline ticket is purchased using a loyalty card corresponding to a passenger enrolled in an airline perk program, identify at least one airline perk associated with an aircraft seat assignment corresponding to the purchased airline ticket, and notify an inflight service provider to deliver, inflight, the at least one identified airline perk to a passenger having the aircraft seat assignment.

The subject matter described herein may be implemented in hardware, software, firmware, or any combination thereof. As such, the terms “function”, “node”, or “module” as used herein refer to hardware, which may also include software and/or firmware components, for implementing the feature being described. In one exemplary implementation, the subject matter described herein may be implemented using a non-transitory computer readable medium having stored thereon computer executable instructions that when executed by the processor and memory of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Preferred embodiments of the subject matter described herein will now be explained with reference to the accompanying drawings, wherein like reference numerals represent like parts, of which:

FIG. 1 is a block diagram illustrating an exemplary system for providing inflight benefits via purchase card transactions according to an embodiment of the subject matter described herein;

FIG. 2 is a block diagram illustrating an exemplary computing platform for providing inflight benefits via purchase card transactions according to an embodiment of the subject matter described herein; and

FIG. 3 is a flow chart illustrating an exemplary process for providing inflight benefits via purchase card transactions according to an embodiment of the subject matter described herein.

### DETAILED DESCRIPTION

In accordance with the subject matter disclosed herein, methods, systems, and computer readable media for providing inflight benefits to loyalty cardholders via payment card transactions are disclosed. The benefits or “perks” may include increased levels of service and/or any other inflight amenity, which may be established and customized by a merchant aircraft or inflight service provider. The benefits or perks are then distributed and/or delivered (e.g., manually or electronically) inflight, at the time of service.

In some embodiments, the disclosed subject matter includes a computing platform referred to as a loyalty program host server (LPHS). The LPHS is configured to host and support a plurality of airline perk management programs associated with a plurality of commercial airlines. In some embodiments, the various airline perk loyalty programs may be implemented by an airline perk management module (APMM) maintained by the LPHS.

In some embodiments, the APMM is configured to notify an inflight service provider (e.g., a merchant airline) of a cardholder's purchase of an airline ticket for a given flight. APMM is also configured to notify the service provider of the cardholder's seat assignment on the aircraft during flight, so that an inflight service provider is notified to distribute or deliver airline perks by aircraft flight attendants on a row-by-row and/or a seat-by-seat basis during a flight. In some embodiments, the APMM includes a computing platform leveraged by inflight service providers, such as commercial airlines, to provide inflight benefit loyalty programs having differently loyalty levels for incentivizing cardholders to continue their patronage to a given airline. The APMM allows inflight service providers to customize loyalty rewards or levels per plane and/or per flight, thereby enabling delivery of tangible/intangible inflight amenities as a viable alternative to the mere accrual of purchase-dependent “miles” or “points” towards flights.

Specifically, a single airline benefit loyalty card reward program may be funded by a single inflight service provider, and optionally managed by a loyalty program host via an LPHS. For each airline benefit loyalty card reward program, an issuing entity may issue a payment card (e.g., a plastic magnetic stripe card, a near field communications (NFC) card, a smartcard with embedded circuitry, and/or an electronic based virtual softcard, each of which may display the airline logo and/or image on a front thereof) to cardholders enrolled in the airline loyalty program, in addition to funding and/or managing a reward/benefit program. As the inflight perks may include different levels of services (e.g., free pillows, blankets, movies), the loyalty perk programs associated therewith can thus be funded at virtually little to no cost to inflight service providers. Notably, the instant subject matter effectively directs frequent-flyer consumers to a specific airline at little to no cost to the airline.

In some embodiments, when an issued airline benefit loyalty card is used by a cardholder to purchase an airline ticket, the APMM is configured to execute the loyalty program stored thereon and notify the inflight service provider to deliver or distribute the benefit to a seat assignment purchased using a loyalty card during the actual time of service (e.g., inflight), which is typically at some time after the initial ticket purchase. Airline perk programs allow inflight service providers to treat individual passengers within a same class (e.g., first class, business class, coach, etc.) differently. The perks may be determined based upon a combination of the seat assignment and a loyalty code level designated to the seat assignment.

The term “merchant airline” includes any and all inflight service providers such as commercial airlines operable in the United States and worldwide, which have been issued an Air Operator Certificate or license issued by a governmental aviation body.

The term “loyalty card” includes any and all payment cards, including any plastic magnetic stripe, NFC, or electronic based virtual softcard not limited to prepaid, credit, and/or debit cards that are enrolled in an airline perk program or airline loyalty program.

The terms “benefit” and “perk” are synonymous and refer to any increased level of service and/or inflight amenity offered, in some embodiments, free of charge, by an inflight service provider as an incentive for purchasing an airline ticket via a loyalty card purchase transaction. The terms “benefit” and “perk” include, but are not limited to, free pillows, blankets, hot towels, food and/or beverages, access to inflight internet (e.g., Wi-Fi), inflight entertainment (e.g., films, access to television, music, video games, etc.) and/or any other amenities available during a flight onboard an aircraft. Notably, distribution of these perks to loyalty consumers allows for individualized, seat-by-seat treatment, so that even travelers in different classes (e.g., first class, business class, coach, etc.) experience individualized, differentiated services and/or amenities.

Although the description herein discloses use of a MasterCard payment network, or portions thereof, any other third party networks or entities may utilize the methods and systems disclosed herein without departing from the scope of the instant subject matter.

Notably, the APMM and its components described herein constitute a special purpose computer or device configured to improve the technological field of payment card reward programs by providing i) an airline perk payment card loyalty or reward program, ii) a computing platform for distribution of customized, flexible inflight benefits to cardholders enrolled in the payment card loyalty or reward program, and iii) differentiated inflight benefits (e.g., increased services, tangible or intangible amenities, etc.) for cardholders that purchase airline tickets using a loyalty card to complete the purchase transaction.

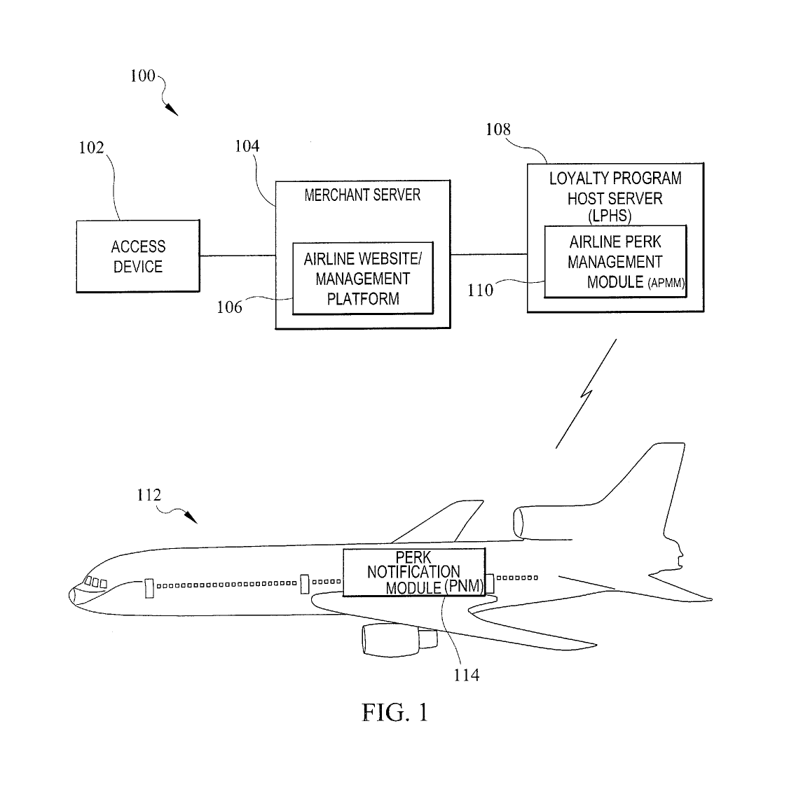

FIG. 1 depicts an exemplary system, generally designated 100, for providing inflight benefits via a payment card transaction. System 100 includes an access device 102, a merchant server 104 configured to host or maintain an airline website or management platform 106, a loyalty program host server (LPHS) 108 configured to host or maintain an airline perk management module (APMM) 110, and an airplane or aircraft 112 including a perk notification module (PNM) 114. Each component within system 100, with the exception of aircraft 112, may be embodied as a computer server, a computing platform, and/or a computer network node capable of sending and receiving electronic communications (e.g., via the Internet, wired and/or wireless communications) with each of the other remaining components of system 100.

In some embodiments, access device 102 includes any electronic and/or web enabled device utilized by a cardholder to complete a purchase transaction via a loyalty card. In some embodiments, a cardholder uses a loyalty card to complete a purchase transaction for at least one airline ticket via a website or website management program 106 hosted by merchant server 104, not limited to a merchant airline or inflight service provider server. Access device 102 includes any computing device (e.g., a personal computer, a mobile smartphone device, a tablet computer, etc.) that is configured communicate with and/or access an airline website or management platform 106 associated with an inflight service provider.

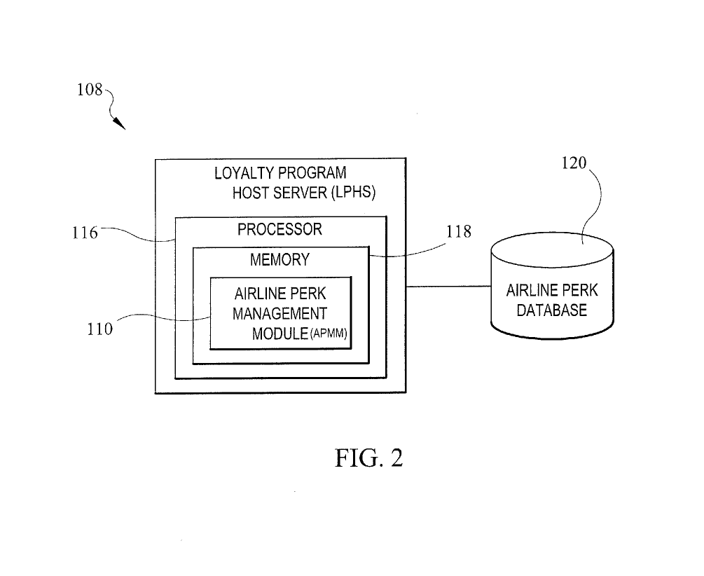

In some embodiments, a cardholder completes a payment transaction (e.g., using a loyalty payment card) for one or more airline tickets via airline website or management platform 106. Merchant server 104 notifies a loyalty program managing entity, which may or may not include a card issuing entity, via LPHS 108 that a transaction for an airline ticket has been made using a loyalty card. APMM 110, which is hosted by LPHS 108, is configured to execute a loyalty program stored thereon prior to and/or during a given flight. The loyalty program accesses a database or data storage unit (e.g., 120, FIG. 2) to determine what inflight benefits should be delivered per plane and/or per flight, based upon the loyalty cardholder's seat assignment. In some embodiments, APMM 110 is configured to trigger delivery of the inflight benefit(s) via PNM 114. Delivery or distribution of one or more tangible or intangible inflight amenities or perks is effected during the actual time of service (i.e., during the flight) either manually (e.g., via a flight attendant) or electronically (e.g., via an onboard entertainment system). In some embodiments, delivery of perks is effected inflight and at the time of service, which is typically some time after the initial airline ticket purchase.

A cardholder completes a payment transaction for one or more airline tickets (e.g., boarding passes) by using device 106 to present, type, and/or otherwise interface a payment card for communicating information thereon to the airline website or management platform 106. Airline website or management platform 106 obtains payment card credentials and related data from the payment card and subsequently generates purchase transaction data. Exemplary purchase transaction data or information may include, but is not limited to, i) a cardholder name; ii) a cardholder account number (e.g., a primary account number or PAN), iii) a Bank Identification Number (“BIN” or “BIN#”), which is also the first 4 or 6 digits of the payment card or account; iv) a merchant/inflight service provider identifier, v) an assigned seat number (e.g., seat assignment) on the aircraft; vi) a purchase transaction amount; etc. The purchase transaction data and, if available, seat assignment information may then be populated and stored in a database (e.g., 120, FIG. 2) maintained by merchant server 104 and/or LPHS 108.

In some embodiments, purchase transaction data may be associated or matched with and/or assigned a loyalty level or loyalty code (e.g., see Table 1 below) via LPHS 108 or APMM 110 as instructed by merchant server 104. Inflight service providers may assign loyalty levels or codes to different benefits (e.g., tangible or intangible inflight amenities). Each seat assignment may then be identified using a loyalty level or code. Thus, one or more databases (e.g., 120, FIG. 2) may be populated with purchase transaction information, loyalty code(s), and/or benefit(s) for distribution inflight.

In some embodiments, APMM 110 sends a wireless communication to PNM 114 just before, at, and/or during the flight, to notify PNM 114 of perk distribution or delivery on an individualized row-by-row and/or seat-by-seat basis. PNM 114 may include a computing platform, node, computer, mobile phone, and/or tablet configured to receive a notification and alert an airline flight attendant to manually distribute perks to loyalty program travelers. In some embodiments, PNM 114 includes a tablet computer providing seat-by-seat instructions as the flight attendant visits each row or seat of the aircraft. For example, PNM 114 may include a tablet computer for instructing the flight attendant to deliver a free pillow, blanket, food and/or beverage item, etc., to a loyalty program cardholder via identifying, or otherwise associating, the cardholder's seat number with a loyalty level. In other embodiments PNM 114 includes a computing device configured to print out a list of seats and cardholders for perk delivery that instructs the flight attendant regarding perk delivery and/or distribution.

In still further embodiments, PNM 114 includes a hardware computing device including an electronic interface, by which a loyalty cardholder swipes his/her loyalty card for initiating an electronic perk delivery. For example, PNM 114 may include an electronic entertainment system disposed onboard aircraft 112, which is configured to deliver an inflight benefit or perk not limited to a free entertainment program (e.g., movie, show, video game, etc.) upon interfacing with cardholder's loyalty card. Thus, PNM 114 is configured to receive an indication that a cardholder is onboard aircraft 112, and electronically deliver the perk to cardholder's seat number at the time of service upon interfacing with cardholder's loyalty card.

Of note, for added security and in some embodiments, a loyalty program cardholder may be provided with a proxy card for triggering inflight perk delivery, which is not the actual credit, prepaid, and/or debit card (e.g., associated with a credit, prepaid, and/or debit account) that actually purchased the one or more airline tickets via the purchase transaction. That is, in some embodiments a cardholder is provided with an entertainment card for use at the time of service (i.e., inflight), which may include a magnetic stripe card and/or a NFC tag configured to interact with an aircraft entertainment system to trigger perk delivery. This increases or adds a level of security, for potentially preventing theft of credit, debit, and/or prepaid card or account information by obviating the need to interface the credit, debit and/or prepaid card enrolled in the loyalty program with the aircraft entertainment system in order to receive loyalty perks. Exemplary PNM devices 114 may include a magnetic stripe reader, a wireless smartcard reader, a wireless device reader, a computer, a computer tablet, an NFC reader, and the like.

Still referring to FIG. 1 and in some embodiments, merchant server 104 includes any server, node, computing platform, computer, or hardware unit configured to process transactions including, inter alia, purchases for airline tickets using loyalty cards. LPHS 108 also includes any server, node, computing platform, computer, or hardware unit, in some embodiments, configured to implement loyalty, benefit, and/or reward program management and monitoring tasks using the methods described herein. APMM 110, residing at LPHS 108, includes a computing platform, computer, or node configured to received purchase transaction data from merchant server 104, and execute an airline payment card reward program for matching purchase transaction data with a loyalty code, perk, and cardholder seat number.

One non-limiting example of a LPHS 108 includes a processing hub or network element associated with MasterCard Main Street, a community reward service from MasterCard International Incorporated of Purchase, N.Y., USA, which facilitates the implementation of APMM 110 to manage and/or monitor aspects of an airline perk or benefit loyalty card reward program. Although FIGS. 1 and 2 depict LPHS 108 as a single network element, LPHS 108 may include a plurality of network elements, a plurality of network components, and/or a network itself (e.g., a MasterCard Network) without departing from the scope of the present subject matter. In some embodiments, LPHS 108 may include a payment card reward system.

Referring now to FIG. 2, a block diagram of an exemplary server or node embodied as LPHS 108 for providing inflight benefits via purchase card transactions is illustrated. LPHS 108 includes a loyalty program management server having at least one processor 116 configured to execute and support APMM 110, thereby managing inflight benefits for various cardholders enrolled in an airline loyalty program. In some embodiments, processor 116 includes a microprocessor, central processing unit (CPU), or any other similar hardware-based processor unit that is configured to execute and/or utilize APMM 110 (e.g., a software based algorithm) to communicate with a data storage unit, such as airline perk database 120, which may be configured to store a plurality of different payment card reward programs (i.e., reward program levels, qualifications, etc.).

In some embodiments, APMM 110 may be stored in a memory 118 element or device of LPHS 108, such as random access memory (RAM), read only memory (ROM), optical read/write memory, cache memory, magnetic read/write memory, flash memory, or any other non-transitory storage media. In one embodiment, processor 116 and memory 118 may be used to execute and manage the operation of APMM 110. In some embodiments, airline perk database 120 includes any medium that is configured to store subscriber profile data and/or airline card reward program data (e.g., loyalty code levels, seat numbers per flight, BIN (i.e., first 4 or 6 numbers of a given payment card), etc.) associated with one or more registered and enrolled loyalty cardholders. Exemplary data storage units, such as airline perk database 120, may include one or more external database servers accessible by LPHS 108. Alternatively, airline perk database 120 may include a local database hosted by LPHS 108. In some embodiments, airline perk database 120 may be provisioned with a plurality of profiles that include the specific parameters corresponding to an inflight benefit and/or perk programs operated by LPHS 108 per plane and/or per flight.

In some embodiments, inflight service providers establish any number of discretionary loyalty codes and/or loyalty code levels for cardholders enrolled in an inflight benefit loyalty program. Loyalty code levels may depend upon a given plane size and/or a distance travelled, and may be matched with a perk and cardholder seat number (#) or assignment. For example, Table 1 below includes an exemplary embodiment of loyalty levels and the perks associated therewith for a given flight, which is either populated and/or accessed by APMM 110.

TABLE 1
INFLIGHT BENEFITS

| | Loyalty | | Cardholder Seat # |
|---|---|---|---|
| Flight Number | Level/Code | Perk | or Assignment |
| 111 | 1 | Free pillow | 2A, 12C, 3E . . . |
| 111 | 2 | Free blanket | 1B, 2E, 12C . . . |
| 111 | 3 | Free movie | 3C, 2A, 12C . . . |
| 222 | 1 | Free hot towel | 15A, 5A, 29B . . . |
| 222 | 2 | Free pillow | 4D, 7A, 19F . . . |
| 222 | 3 | Free blanket | 1A, 3F, 5D . . . |
| 222 | 4 | Free movie | 2C, 3A, 4D . . . |
| 222 | 5 | Free food item | 5A, 17D, 20A . . . |
| 333 | 1 | Free pillow | 3A, 4A, 5C . . . |
| 333 | 2 | Free movie | 10A, 11A, 12A . . . |
| 333 | 3 | Free beverage item | 1B, 4A, 6C . . . |
| 333 | 4 | Free Wi-Fi access | 5B, 6D, 7A . . . |

As Table 1 illustrates above, flight 111 includes at least three loyalty levels, flight 222 includes at least five loyalty levels, and flight 333 includes at least four loyalty levels. The loyalty levels and amenity/perk associated with each level are established at the discretion of an inflight service provider, and can be communicated between merchant server 104 and LPHS 108. In other embodiments, information including loyalty levels, amenities, and seat assignments are stored at and/or matched and populated via APMM 110, and then stored at airline perk database 120, accessed via LPHS 108, and communicated to PNM 114 (FIG. 1) at the time of service, while the loyalty passenger cardholder is inflight.

As Table 1 illustrates, cardholders may qualify for more than one level of service. The cardholder in seat 12C aboard flight 111 qualifies for all three levels of service and/or perks. As seat 12C may be indicative of a traveler in coach, the service for that individual may be upgraded and/or differentiated from other members of coach. Thus, inflight service providers can customize and/or provide increased levels of services and/or amenities to loyalty program cardholders as appreciation for continued patronage to that provider, at little to no cost to the provider. The number of loyalty levels and perks can be customized by the inflight service provider and at the provider's discretion. Thus, different inflight service providers can offer different and different loyalty programs to incentivize travelers to choose that merchant over others. Information, such as information in Table 1 above, may be stored in airline perk database 120 and/or accessed compiled thereby for use by APMM 110.

Once APMM 110 determines that passenger(s) onboard a given flight are entitled to receive a perk or benefit, APMM 110 notifies PNM 114 (FIG. 1) either wirelessly or via other signal or communication protocol to trigger delivery or distribution of perks to travelers on a seat-by-seat basis. In some embodiments, an airline representative (e.g., an airline administrator) may access a website or management platform 106 (FIG. 1) establish inflight perks and loyalty levels associated with each plane and/or flight. An “issuer entity” may include an independent bank or credit union that is licensed and authorized to program and manage LPHS 108 (e.g., MasterCard International) and issue payment cards (e.g., credit cards, prepaid cards, etc.) to enrolling consumers. APMM 110 is configured to execute loyalty programs, for example, inflight benefit programs for different inflight service providers by accessing and utilizing airline perk database 120. An airline representative (e.g., an airline flight attendant) may be instructed via APMM 110 (e.g., upon interfacing with PNM 114, FIG. 1) to distribute or deliver perks, inflight to loyalty cardholders who purchased their airline tickets using an issued loyalty card.

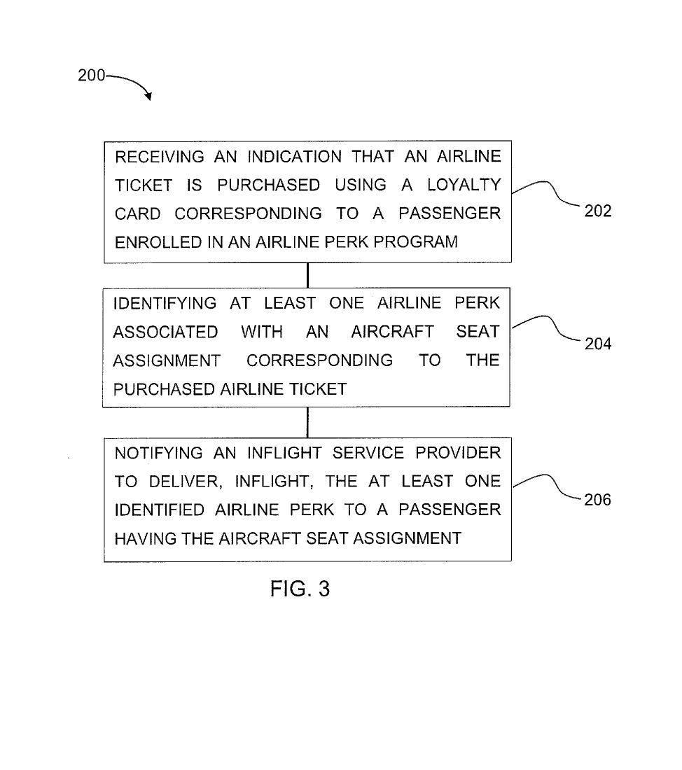

FIG. 3 depicts a flow chart illustrating an exemplary method 200 for providing inflight benefits via payment card transactions. In block 202, an inflight benefit system receives an indication that that an airline ticket is purchased using a loyalty card corresponding to a passenger enrolled in an airline perk program. For example, APMM 110 (FIG. 2) may receive transaction and/or payment information from a merchant server 104, such as a merchant inflight provider server, that a loyalty cardholder passenger has completed a payment card transaction for one or more airline tickets via a loyalty card. In some embodiments, APMM 110 receives an indication that an airline ticket is purchased by a loyalty card enrolled in an airline perk program. APMM 110 can then execute a loyalty program, access stored information, and determine that an airline perk is assigned.

In block 204, at least one airline perk is identified with an aircraft seat assignment corresponding to a purchased airline ticket. In some embodiments, APMM 110 (FIG. 2) accesses data stored within an airline perk database 120 (FIG. 2) to determine that an airline perk is assigned to a seat and/or row number of a given aircraft. The airline perk can be determined based upon a combination of a seat assignment and a loyalty level, or loyalty code.

In block 206, the inflight service provider (e.g., an employee or component thereof) is notified to deliver the airline perk to a passenger having the seat assignment purchased using the loyalty card, inflight, at a time of service. The notification may be sent to an electronic device within an aircraft (e.g., a computer, tablet, handheld device). In other embodiments, the notification may be sent to a computer and printed therefrom. In yet further embodiments, the notification may be sent to an onboard aircraft entertainment system or device (e.g., disposed at a given seat upon the aircraft) upon interfacing a cardholder's loyalty card or a proxy loyalty card with the onboard entertainment device or system. Thus, inflight perk delivery may be manual (e.g., via an airline flight attendant) or electronic (e.g., via interfacing an aircraft entertainment system). In some aspects, APMM 110 (FIG. 2) communicates a notification to an onboard entertainment system using LPHS 108 (FIG. 2) of the aircraft instructing the system to effect presentation of a free onboard entertainment item. The onboard entertainment item may include a free movie, free music, a free video game, or combinations thereof.

Systems, methods, and computer readable media for providing inflight benefits via payment card transactions can provide, for example and without limitation, one or more of the following beneficial technical effects: an alternative to traditional loyalty programs and payment transactions, in which tangible or intangible inflight amenities or benefits are distributed to loyalty program cardholders; delivery of seat-by-seat benefits at a time of service (e.g., not the time of purchase); differentiation of individuals (e.g., by inflight perk distribution) within a same class via purchase transactions; improved perk delivery; faster perk delivery; and/or more secure access to perks via interfacing an aircraft entertainment system.

While the subject matter has been has been described herein in reference to specific aspects, features, and illustrative embodiments, it will be appreciated that the utility of the subject matter is not thus limited, but rather extends to and encompasses numerous other variations, modifications and alternative embodiments, as will suggest themselves to those of ordinary skill in the field of the present subject matter, based on the disclosure herein.

Various combinations and sub-combinations of the structures and features described herein are contemplated and will be apparent to a skilled person having knowledge of this disclosure. Any of the various features and elements as disclosed herein can be combined with one or more other disclosed features and elements unless indicated to the contrary herein. Correspondingly, the subject matter as hereinafter claimed is intended to be broadly construed and interpreted, as including all such variations, modifications and alternative embodiments, within its scope and including equivalents of the claims.

What is claimed is:

1. A method of providing inflight benefits via payment card transactions, the method comprising:
at an airline perk management module (APMM):
receiving an indication that an airline ticket is purchased using a loyalty card corresponding to a passenger enrolled in an airline perk program;
identifying at least one airline perk associated with an aircraft seat assignment corresponding to the purchased airline ticket; and
notifying an inflight service provider to deliver, inflight, the at least one identified airline perk to a passenger having the aircraft seat assignment.

2. The method of claim 1, wherein receiving an indication that an airline ticket is purchased using a loyalty card corresponding to a passenger enrolled in an airline perk program includes receiving purchase transaction data from a merchant server.

3. The method of claim 2, wherein identifying at least one airline perk associated with the aircraft seat assignment corresponding to the purchased ticket includes assigning a loyalty code to the purchase transaction data, and associating the loyalty code with the seat assignment.

4. The method of claim 2, wherein the purchase transaction data includes a cardholder name, a cardholder account number, or a Bank Identification Number (BIN).

5. The method of claim 1, wherein the airline perk includes at least one of a pillow, a blanket, a hot towel, a food item, a beverage item, access to wireless Internet, or access to inflight entertainment.

6. The method of claim 1, wherein notifying the inflight service provider to deliver the airline perk includes sending a notification to a computer tablet that is accessibly by an airline flight attendant.

7. The method of claim 1, wherein notifying the inflight service provider to deliver the airline perk includes sending a notification to an onboard entertainment system to deliver a free onboard entertainment item.

8. The method of claim 7, wherein the free onboard entertainment item includes a free movie, free music, a free video game, or combinations thereof.

9. The method of claim 1, wherein identifying at least one airline perk associated with an aircraft seat assignment corresponding to the purchased airline ticket includes identifying a plurality of different airline perks associated with a plurality of different aircraft seat assignments for a plurality of different passengers, wherein the airline tickets corresponding to the plurality of different aircraft seat assignments were purchased using a loyalty card enrolled in an airline perk program.

10. The method of claim 1, wherein the least one identified airline perk is based upon a combination of the seat assignment and a loyalty level.

11. A system for providing inflight benefits via purchase card transactions, the system comprising:
at least one processor;
memory; and
an airline perk management module (APMM) utilizing the at least one processor and the memory, wherein the APMM is configured to:
receive an indication that an airline ticket is purchased using a loyalty card corresponding to a passenger enrolled in an airline perk program;
identify at least one airline perk associated with an aircraft seat assignment corresponding to the purchased airline ticket; and
notify an inflight service provider to deliver, inflight, the at least one identified airline perk to a passenger having the aircraft seat assignment.

12. The system of claim 11, wherein the APMM is configured to receive purchase transaction data from a merchant server, assign a loyalty code to the purchase transaction data, and associate the seat assignment to the loyalty code.

13. The system of claim 12, wherein the purchase transaction data includes a cardholder account number or a Bank Identification Number (BIN).

14. The system of claim 11, wherein the airline perk includes at least one of a pillow, a blanket, a hot towel, a food item, a beverage item, access to wireless Internet, or access to inflight entertainment.

15. The system of claim 11, wherein APMM triggers delivery of the at least one airline perk to the passenger having the aircraft seat assignment by notifying a perk notification module (PNM) disposed onboard the aircraft.

16. The system of claim 15, wherein the PNM comprises a computer tablet that is accessibly by an airline flight attendant.

17. The system of claim 15, wherein the PNM comprises an onboard entertainment system configured to deliver a free onboard entertainment item.

18. The system of claim 17, wherein the free onboard entertainment item includes a free movie, free music, a free video game, or combinations thereof.

19. The system of claim 11, wherein the APMM determines that a plurality of airline perks are associated with a seat number purchased using the loyalty card and the inflight service provider delivers the plurality of airline perks, inflight, to the passenger having the aircraft seat assignment.

20. The system of claim 11, wherein the least one airline perk is based upon a combination of the seat assignment and a loyalty level.

21. A non-transitory computer readable medium having stored thereon executable instructions for controlling a computer to perform steps comprising:
receiving an indication that an airline ticket is purchased using a loyalty card corresponding to a passenger enrolled in an airline perk program;
identifying at least one airline perk associated with an aircraft seat assignment corresponding to the purchased airline ticket; and
notifying an inflight service provider to deliver, inflight, the at least one identified airline perk to a passenger having the aircraft seat assignment.
